(19) United States
(12) Patent Application Publication
(10) Pub. No.: US 2026/0153216 A1
(43) Pub. Date: Jun. 4, 2026

(54) LIGHT GUIDE FIXING ASSEMBLY, LIGHTING OR SIGNAL INDICATING DEVICE AND MOTOR VEHICLE

(71) Applicant: VALEO VISION, Bobigny (FR)

(72) Inventors: Yajun WANG, Wuhan (CN); Sha LIU, Wuhan (CN); Qiwei ZHANG, Wuhan (CN); Shuo ZHOU, Wuhan (CN)

(73) Assignee: VALEO VISION, Bobigny (FR)

(21) Appl. No.: 19/124,142

(22) PCT Filed: Oct. 25, 2023
(86) PCT No.: PCT/EP2023/079727

§ 371 Date: Apr. 24, 2025

(30) Foreign Application Priority Data
Oct. 26, 2022 (CN) 202222869847.6

(51) Int. Cl. F21S 43/50; B60Q 1/26; F21S 43/237; F21S 43/27

(52) U.S. Cl. CPC F21S 43/50; B60Q 1/2619; F21S 43/237; F21S 43/27

(57) ABSTRACT

A light guide fixing assembly, a lighting or signal indicating device and a motor vehicle are provided. The light guide fixing assembly is used to fix two light guides, each light guide has an opposing first end and second end, and the first end has a mounting portion. The light guide fixing assembly includes a fixing base and a fastener, constructed to fix the mounting portions of the first ends of the two light guides to the fixing base by pressing them against the fixing base, so that the fastener separates the two mounting portions of the first ends of the two light guides in a first direction.

### TECHNICAL FIELD

Embodiments of the present disclosure in general relate to the field of lighting and/or signal indication, and in particular to a light guide fixing assembly capable of preventing mixing of light between two light guides, and a lighting or signal indicating device and a motor vehicle equipped with such a light guide fixing assembly.

### BACKGROUND OF THE INVENTION

Various lighting or signal indicating devices are known in various fields for providing light for lighting or signal indication. For example, vehicle lamps are used in motor vehicles to provide lighting or signal indicating functions, in order to ensure safe driving or provide an ornamental function.

As an optical element, light guides are often used in the lamps of motor vehicles to guide light from a light source to a desired position or direction. In practical applications, two or more light guides for different lighting or signal indicating functions are usually fixed side by side, depending on the design or installation requirements. In some conventional vehicle lights, there is an overlap at the structure that fixes adjacent light guides, for example, between the mounting parts of adjacent light guides. In the case of light leakage, light from one light guide may enter another light guide, resulting in possible mixing of light or colors between adjacent light guides.

### SUMMARY OF THE INVENTION

One purpose of the present disclosure is to solve or overcome at least one of the above and other problems and shortcomings in the prior art.

In one aspect of the present disclosure, a light guide fixing assembly is provided, used for fixing two light guides, each light guide has an opposing first end and second end, and the first end has a mounting portion; the light guide fixing assembly comprises: a fixing base; and a fastener, constructed to fix the mounting portions of the first ends of the two light guides to the fixing base by pressing them against the fixing base, so that the fastener separates the two mounting portions of the first ends of the two light guides in a first direction.

In some embodiments, the fastener is sized in a second direction perpendicular to the first direction such that the fastener is capable of completely separating the two mounting portions of the first ends of the two light guides, to prevent the two mounting portions of the two light guides from directly facing each other in the first direction.

In some embodiments, the fixing base is formed with a rib having a width in the second direction perpendicular to the first direction such that the rib cooperates with the fastener to completely separate the two mounting portions of the light guides, to prevent the two mounting portions of the two light guides from directly facing each other in the first direction.

In some embodiments, the rib has an abutting portion, which is adapted to abut the fastener in the second direction or be positioned adjacent to the fastener when the fastener is fixed to the fixing base, and is located between portions of the two mounting portions of the two light guides that face each other in the first direction.

In some embodiments, the fixing base is formed with two ribs spaced apart in the second direction.

In some embodiments, the fixing base comprises a column extending in a third direction perpendicular to the first direction and the second direction, and the ribs are at least partially formed on an outer circumferential surface of the column and extend along the third direction.

In some embodiments, the fixing base is formed with a mounting hole, and the fastener is adapted to be at least partially inserted and fixed in the mounting hole.

In some embodiments, the fixing base has a mounting surface, and the fastener is adapted to press the two mounting portions of the first ends of the two light guides against the mounting surface.

In some embodiments, the fastener comprises a rod with external threads and a head, the external threads of the rod are adapted to engage with internal threads of the mounting hole, and the head has a diameter greater than that of the rod to press the mounting portion at least partially against the mounting surface.

In some embodiments, the light guide fixing assembly further comprises: a gasket, adapted to be pressed by the head against the two mounting portions of the two light guides. In some embodiments, the light guide fixing assembly further comprises a supporting body formed with two grooves and a middle ridge located between the two grooves, each groove is elongated and adapted to receive one of the light guides, and the middle ridge is constructed to separate the two light guides received in the two grooves in the first direction.

In some embodiments, the fixing base is formed on the supporting body or is formed as a part of the supporting body.

In some embodiments, the supporting body is further formed with side ridges, which are located on a side of each groove opposite the middle ridge in the first direction, so that each light guide is held between the corresponding side ridge and the middle ridge.

According to another aspect of the present disclosure, a lighting or signal indicating device is also provided in the embodiments, comprising two elongated light guides arranged side by side and the light guide fixing assembly as described in any of the embodiments of the present disclosure, and the light guides are fixed by the light guide fixing assembly.

In some embodiments, one of the two light guides is constructed to guide light for a first lighting or signal indicating function, and the other light guide is constructed to guide light for a second lighting or signal indicating function.

In some embodiments, the lighting or signal indicating device comprises a vehicle light for a motor vehicle.

In some embodiments, one of the two light guides is constructed to guide light for one of the functions of a tail light, a parking light, a brake light and a rear turn signal, and the other light guide is constructed to guide light for another of the functions of a tail light, a parking light, a brake light and a rear turn signal; or one of the two light guides is constructed to guide light for one of the functions of a daytime running light, a side light and a front turn signal, and the other light guide is constructed to guide light for another of the functions of a daytime running light, a side light and a front turn signal.

According to yet another aspect of the present disclosure, a motor vehicle is further provided in the embodiments, comprising the light guide fixing assembly as described in any of the embodiments of the present disclosure, or comprising the lighting or signal indicating device as described in any of the embodiments of the present disclosure.

A detailed description of the present disclosure below with reference to the attached drawings will make other objectives and advantages of the present disclosure apparent and help achieve a comprehensive understanding of the present disclosure.

### BRIEF DESCRIPTION OF DRAWINGS

These and/or other aspects, features and advantages of the present disclosure will become apparent and readily understood from the following description of some illustrative embodiments in conjunction with the accompanying drawings. In the drawings:

FIG. 1 is a perspective view schematically showing the structure of a part of the lighting or signal indicating device according to an exemplary embodiment of the present disclosure;

FIG. 2 is a perspective view schematically showing the structure for fixing light guides of the lighting or signal indicating device according to an exemplary embodiment of the present disclosure, wherein the light guides are removed;

FIG. 3 is a detail view of the structure in the dotted circle in FIG. 2;

FIG. 4 is a perspective view schematically showing the layout of the light guides of the lighting or signal indicating device according to an exemplary embodiment of the present disclosure;

FIG. 5 is a detail view of the structure in the dotted circle in FIG. 4;

FIG. 6 is a side perspective view schematically showing a partial structure of the lighting or signal indicating device according to an exemplary embodiment of the present disclosure; and

FIG. 7 is a section view schematically showing a partial structure of the lighting or signal indicating device according to an exemplary embodiment of the present disclosure.

### DETAILED DESCRIPTION OF THE INVENTION

Embodiments of the present disclosure will be described in detail below in conjunction with the attached drawings. In this description, the same or similar components are indicated by the same or similar reference numerals. The following explanation of embodiments of the present disclosure with reference to the drawings are intended to explain the overall disclosed concept of the present disclosure, and should not be interpreted as a limitation of the present disclosure.

In addition, in the following detailed description, for ease of explanation, many specific details are given to provide a comprehensive understanding of the embodiments of the present disclosure. However, it is obvious that one or more embodiments may also be implemented without these specific details. In other cases, well-known structures and devices are shown in the form of illustrations to simplify the drawings.

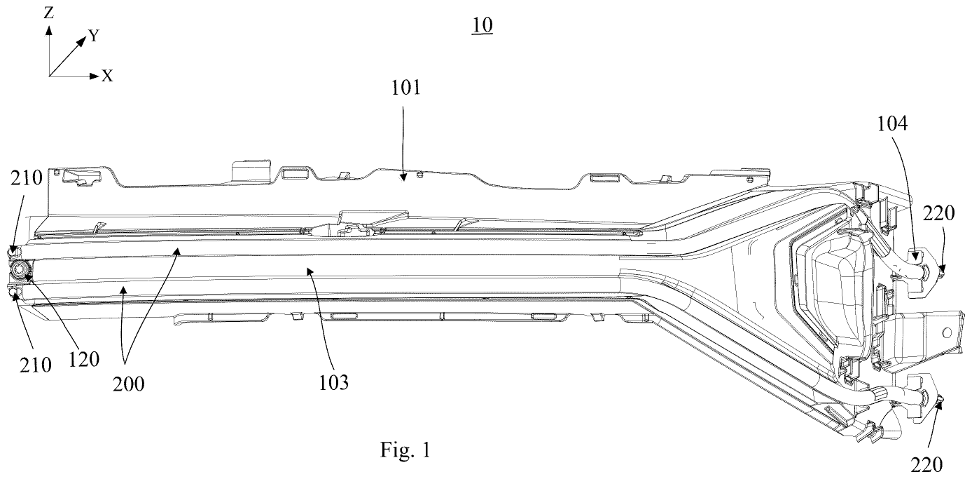

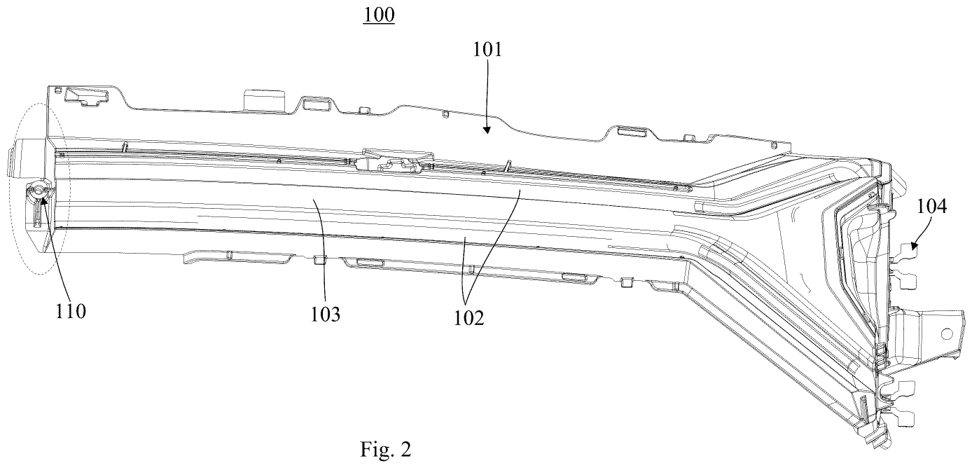

FIG. 1 schematically shows the structure of a part of the lighting or signal indicating device 10 provided according to an exemplary embodiment of the present disclosure. As described below, the device may be used as, for example, a vehicle light of a motor vehicle. As shown in FIGS. 1 and 2, the lighting or signal indicating device 10 comprises a light guide fixing assembly 100 for fixing two or more light guides 200. In the illustrated embodiment, each light guide 200 is elongated and has the opposing first end 210 and second end 220. The first end 210 has a mounting portion 211 to be fixed by the light guide fixing assembly 100. The second end 220 faces a light source, for example, an LED (not shown). Light from the light source enters the light guides 200 from the second end 220 and propagates therein, and at least a part of the side of the light guide 200 along its length may be formed with a light emitting structure to guide the light to exit in a desired direction with a certain distribution, to provide a lighting or signal indicating function. As described below, the two light guides 200 may provide or guide light for different lighting or signal indicating functions.

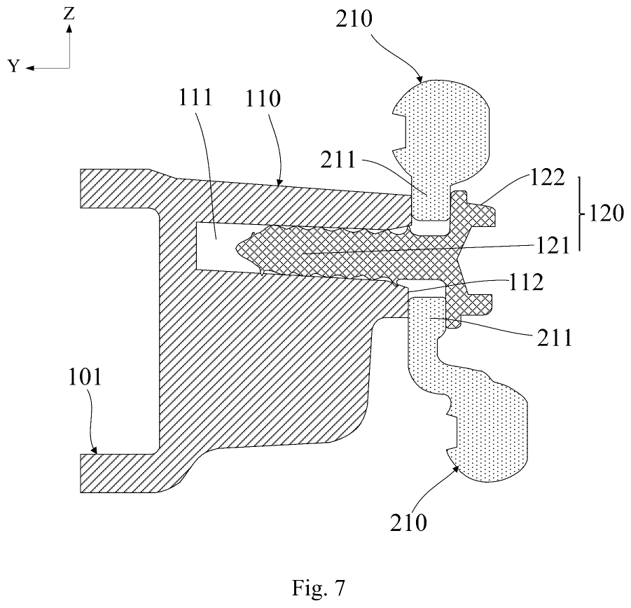

In the illustrated embodiment, as shown in FIGS. 2 to 3 and 6 to 7, the light guide fixing assembly 100 comprises a fixing base 110 and a fastener 120, the fastener 120 can be fixed to the fixing base 110 to press the two mounting portions 211 of the first ends 210 of the two light guides 200 against the fixing base 110, and the fastener 120 separates the two mounting portions 211 of the first ends 210 of the two light guides 200 in the first direction Z, blocking the propagation of light between the two mounting portions 211, thereby preventing light leaking from the first end of one light guide from entering the other light guide through the mounting portion at the first end, thus preventing the problem of mixing of light for different lighting or signal indicating functions. In some examples, the first direction Z may be the vertical direction, but the disclosure is not limited thereto. The first direction depends on the actual layout requirements or design of the light guides.

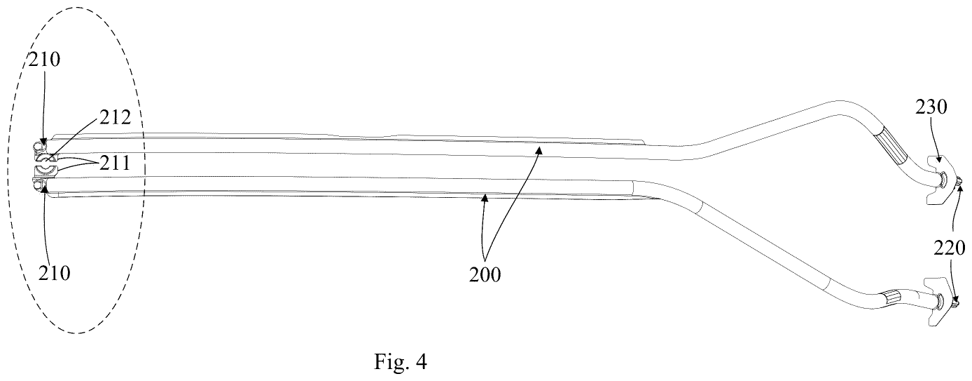

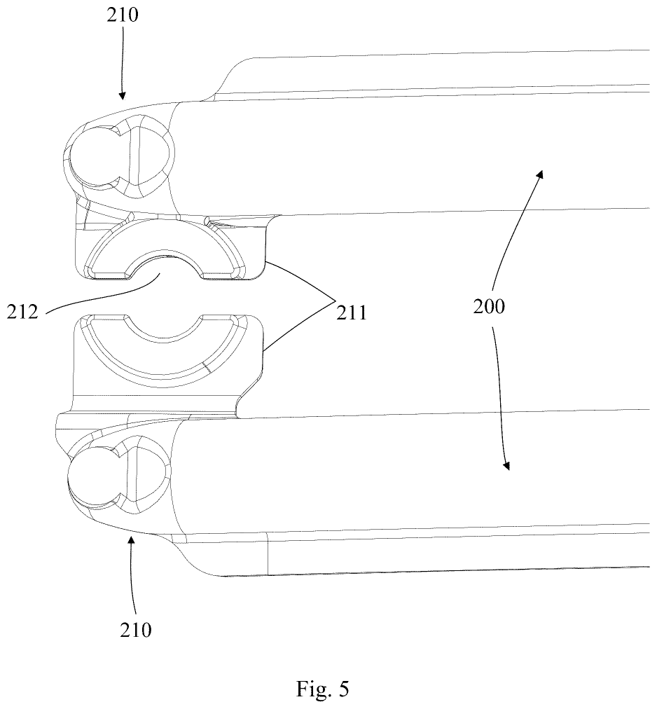

As an example, preferably as shown in FIGS. 4 and 5, the mounting portion 211 at the first end 210 of each light guide 200 may comprise an arc or semicircular profile with a notch 212. When pressed against the fixing base 110, the notches 212 of the two mounting portions 211 face each other, forming an incomplete circular shape with an opening or gap in the second direction X to partially encircle the fastener 120 for positioning. As an example, as shown in the figures, the two light guides 200 are arranged side by side, extending from the second end 220 close to the light source to the first end 210 fixed by the light guide fixing assembly 100, they have at least a light exiting section, for example, extending along the second direction X, and the light propagating in the light guides exits from the light exiting section in the desired direction.

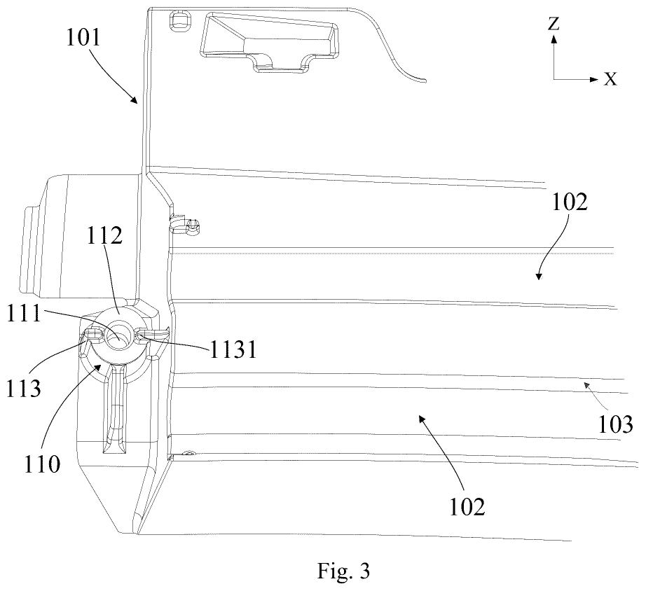

As shown in FIGS. 3, 6 and 7, the fixing base 110 may be formed with a mounting hole 111, and the fastener 120 is adapted to be at least partially inserted and fixed in the mounting hole 111, to firmly press the mounting portions 211 against the fixing base 110. For example, the end of the fixing base 110 facing the mounting portions 211 may have an abutting surface or mounting surface 112, and the fastener 120 may press the two mounting portions 211 of the first ends 210 of the two light guides 200 against the mounting surface 112.

As an example, the fastener 120 may comprise a screw or threaded component having a rod 121 with external threads and a head 122 with a greater diameter. The mounting hole 111 of the fixing base 110 has internal threads, the external threads of the rod 121 are adapted to engage with the internal threads of the mounting hole 111, and the diameter of the head 122 is greater than that of the rod 121, to press the mounting portions 211 of the light guides 200 at least partially against the mounting surface 112 of the fixing base 110.

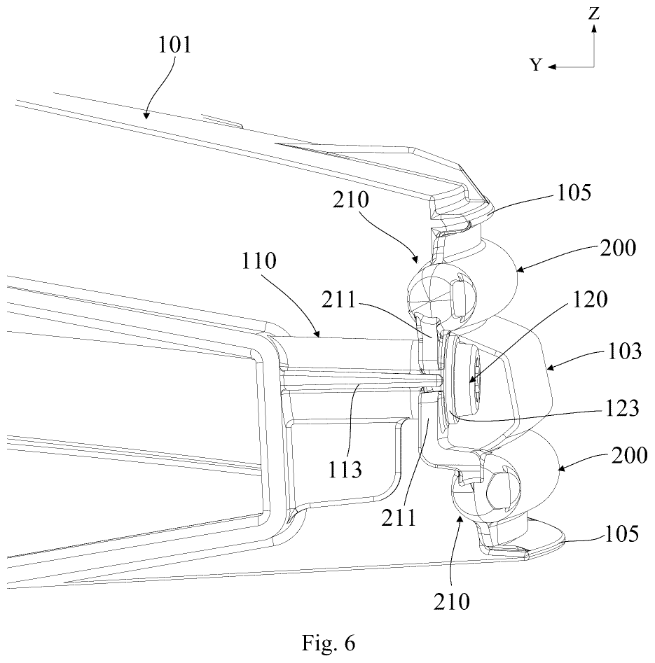

In some embodiments, as shown in FIG. 6, the light guide fixing assembly 100 may further comprise or be provided with a gasket 123, for example, a washer. The gasket 123 can be positioned or pressed between the head 122 of the fastener 120 and the two mounting portions 211 of the two light guides 200, to increase the contact area of the pressed portions of the mounting portions of the light guides, which can increase friction, further improving the fixing effect of the light guides. As an example, the contour dimension or outer diameter of the gasket may be greater than that of the head, to increase the contact area for fastening the light guides.

According to an exemplary embodiment of the present disclosure, the two mounting portions 211 of the first ends 210 of the two light guides 200 are pressed against the same fixing base 110 by a single fastener 120, separated in the first direction Z, and there is no overlap or stacking between the two mounting portions 211, which can effectively prevent the problem of mixed light caused by light leakage.

In some embodiments, the fastener 120 may be sized to be large enough in the second direction X perpendicular to the first direction Z, so that the fastener 120 itself can completely separate the mounting portions 211 of the first ends 210 of the two light guides 200. For example, the size of the part of the fastener 120 located between the two mounting portions 211 (for example, the rod 121) in the second direction X is equal to or greater than the size of the mounting portions 211 in the second direction X, to prevent the mounting portions 211 of the two light guides 200 from directly facing each other in the first direction Z, thereby preventing light leaking from the first end or mounting portion of one light guide from entering the other light guide through the mounting portion on the first end of the other light guide.

In some other embodiments, the fixing base itself or a part thereof that cooperates with the fastener can be positioned between the first ends or mounting portions of the two adjacent light guides in the first direction Z, and can also function as a light shield, i.e., at least partially block the light leaking at the first end of one light guide or the mounting portion thereof from entering the other light guide. For example, in the case where the size of the mounting portions 211 of the light guides 200 in the second direction is greater than the size of the part of the fastener 120 located between the two mounting portions 211 (for example, the rod 121) in the second direction X, the fixing base that cooperates with the fastener can provide an additional light-shielding structure to cooperate with the fastener to prevent light leaking from the first end or the mounting portion of one light guide from entering the other light guide through the mounting portion on the first end of the other light guide.

In the illustrated embodiment, the fixing base 110 is formed with a rib 113 having a certain size or width in the second direction X. The rib 113 cooperates with the fastener 120, for example, with the rod 121, to completely separate the two mounting portions 211 of the two light guides 200, to prevent the mounting portions 211 of the two light guides 200 from directly facing each other in the first direction Z, thereby providing a more complete light shielding effect.

In the illustrated embodiment, the fixing base 110 is formed as a column extending in a third direction Y perpendicular to the first direction Z and the second direction X, and the rib 113 is at least partially formed on the outer circumferential surface of the column and extends along the third direction Y. In some embodiments, as shown in FIGS. 2, 3 and 6, the fixing base 110 may be formed with two ribs 113 spaced apart in the second direction X, which are respectively located on the sides opposite the mounting hole 111 and thus can be located on the side opposite the rod 121 in the second direction X.

As an example, at least a part of the rib 113 may be located between the two mounting portions 211 in the first direction Z, for example, between the portions of the two mounting portions 211 that are not shielded by the fastener 120, thereby cooperating with the fastener 120 to provide a complete light shielding effect for both mounting portions 211.

In the illustrated embodiment, with reference to FIGS. 2, 3 and 6, the rib 113 may have an abutting portion 1131. When the fastener 120 is fixed to the fixing base 110, the abutting portion 1131 can abut the fastener 120 or be positioned adjacent to the fastener 120 in the second direction X, and is located in the gap between the portions of the two mounting portions 211 of the two light guides 200 that face each other in the first direction Z. As shown in the figures, the abutting portion 1131 may be formed on the mounting surface 112.

In some embodiments, as shown in FIGS. 1 to 3 and 6, the light guide fixing assembly 100 further comprises a supporting body 101, and the supporting body 101 is formed with two grooves 102 and a middle ridge 103 located between the two grooves 102. Each groove 102 is elongated and extends along the direction in which the light guides 200 are arranged, each light guide 200 may be positioned in one groove 102, and the middle ridge 103 may separate the two light guides 200 received in the two grooves 102 in the first direction Z, thereby preventing light mixing or interference in the light exiting region of the light guides. As shown in the figures, the ridge 103 may protrude further in the third direction Y than the light guides 200 positioned in the grooves 102 do, to provide light shielding. In addition, a clamping structure 104 may be formed close to the second ends 220 of the light guides 200 on the supporting body 101, to keep the second ends 220 of the light guides 200 fixed relative to the supporting body 101. In applications where the lighting or signal indicating device 10 is used as a vehicle light, the supporting body 101 may be the housing of the vehicle light or a part thereof. In some examples, the fixing base 110 may be formed on the supporting body 101 or formed as a part of the supporting body 101.

In the exemplary embodiment shown in FIGS. 1 to 3 and 6, the supporting body 101 may be further formed with side ridges 105. The side ridges 105 protrude outward in the third direction Y and are located on the outer side of each groove 102 or on the side opposite the middle ridge 103 in the first direction Z, for positioning the light guides. They may extend side by side with the grooves 102 to firmly hold and position each light guide 200 between the corresponding side ridge 105 and the middle ridge 103, thereby preventing the light guides 200 or the mounting portions 211 thereof from moving outwards or falling off in the first direction Z.

In the lighting or signal indicating device provided according to exemplary embodiments of the present disclosure, one of the two light guides 200 held by the same light guide fixing assembly 100 may be used to guide or provide light for a first lighting or signal indicating function, while the other light guide may be used to guide or provide light for a different second lighting or signal indicating function. As an example, in a motor vehicle, one of the two light guides of the lighting or signal indicating device provided may be used to guide or provide light for one of the functions of a tail light, a parking light, a brake light and a rear turn signal, and the other light guide may be used to guide or provide light for another of the functions of a tail light, a parking light, a brake light and a rear turn signal; or, one light guide may be used to guide or provide light for one of the functions of a daytime running light, a side light and a front turn signal, and the other light guide may be used to guide or provide light for another of the functions of a daytime running light, a side light and a front turn signal.

The embodiments of the present disclosure also provide a motor vehicle comprising the light guide fixing assembly or the lighting or signal indicating device as described in any of the above embodiments.

Although the present disclosure has been described in conjunction with the accompanying drawings, the embodiments disclosed in the drawings are intended to illustrate embodiments of the present disclosure and should not be construed as limiting the present disclosure. The dimensional proportions in the drawings are merely schematic, and must not be interpreted as a limitation of the present disclosure.

Although some embodiments of the general concept of the present disclosure have been shown and described, those ordinarily skilled in the art will understand that changes can be made to these embodiments without departing from the principle and motivation of the general concept of the present disclosure. The scope of the present disclosure is defined by the claims and their equivalents.

What is claimed is:

1. A light guide fixing assembly, used to fix two light guides, each light guide having an opposing first end and second end, the first end having a mounting portion, the light guide fixing assembly comprises:
a fixing base; and
a fastener, constructed to fix the mounting portions of the first ends of the two light guides to the fixing base by pressing them against the fixing base, so that the fastener separates the two mounting portions of the first ends of the two light guides in a first direction.

2. The light guide fixing assembly according to claim 1, wherein the fastener is sized in a second direction perpendicular to the first direction such that the fastener is capable of completely separating the two mounting portions of the first ends of the two light guides, to prevent the two mounting portions of the two light guides from directly facing each other in the first direction.

3. The light guide fixing assembly according to claim 1, wherein the fixing base is formed with a rib having a width in the second direction perpendicular to the first direction such that the rib cooperates with the fastener to completely separate the two mounting portions of the light guides, to prevent the two mounting portions of the two light guides from directly facing each other in the first direction.

4. The light guide fixing assembly according to claim 3, wherein the rib has an abutting portion, which is adapted to abut the fastener or be positioned adjacent to the fastener in the second direction when the fastener is fixed to the fixing base, and is located between portions of the two mounting portions of the two light guides that face each other in the first direction.

5. The light guide fixing assembly according to claim 3, wherein the fixing base is formed with two ribs spaced apart in the second direction.

6. The light guide fixing assembly according to claim 5, wherein the fixing base includes a column extending in a third direction perpendicular to the first direction and the second direction, and the ribs are at least partially formed on an outer circumferential surface of the column and extend along the third direction.

7. The light guide fixing assembly according to claim 1, wherein the fixing base is formed with a mounting hole, and the fastener is adapted to be at least partially inserted and fixed in the mounting hole.

8. The light guide fixing assembly according to claim 7, wherein the fixing base has a mounting surface, and the fastener is adapted to press the two mounting portions of the first ends of the two light guides against the mounting surface.

9. The light guide fixing assembly according to claim 8, wherein the fastener includes a rod with external threads and a head the external threads of the rod are adapted to engage with internal threads of the mounting hole, and the head has a diameter greater than that of the rod to press the mounting portions at least partially against the mounting surface.

10. The light guide fixing assembly according to claim 9, further comprising:
a gasket, adapted to be pressed by the head against the two mounting portions of the two light guides.

11. The light guide fixing assembly according to claim 1,
further comprising a supporting body formed with two grooves and a middle ridge located between the two grooves, each groove being elongated and adapted to receive one of the light guides, and
the middle ridge is constructed to separate the two light guides received in the two grooves in the first direction.

12. The light guide fixing assembly according to claim 11, wherein
the fixing base is formed on the supporting body or is formed as a part of the supporting body.

13. The light guide fixing assembly according to claim 11, wherein the supporting body is further formed with side ridges, which are located on a side of each groove opposite the middle ridge in the first direction, so that each light guide is held between the corresponding side ridge and the middle ridge.

14. A lighting or signal indicating device, comprising two elongated light guides arranged side by side, and a light guide fixing assembly, the light guides are fixed by the light guide fixing assembly, with the light guide fixing assembly including a fixing base and a fastener, constructed to fix the mounting portions of the first ends of the two light guides to the fixing base by pressing them against the fixing base, so that the fastener separates the two mounting portions of the first ends of the two light guides in a first direction.

15. The lighting or signal indicating device according to claim 14, wherein one of the two light guides is constructed to guide light for a first lighting or signal indicating function, and the other light guide is constructed to guide light for a second lighting or signal indicating function.

16. The lighting or signal indicating device according to claim 15, wherein the lighting or signal indicating device includes a vehicle light used for a motor vehicle.

17. The lighting or signal indicating device according to claim 16, wherein,
one of the two light guides is constructed to guide light for one of the functions of a tail light, a parking light, a brake light and a rear turn signal, and the other light guide is constructed to guide light for another of the functions of a tail light, a parking light, a brake light and a rear turn signal; or
one of the two light guides is constructed to guide light for one of the functions of a daytime running light, a side light and a front turn signal, and the other light guide is constructed to guide light for another of the functions of a daytime running light, a side light and a front turn signal.

18. A motor vehicle, comprising a lighting or signal indicating device, with the lighting or signal indicating device including two elongated light guides arranged side by side and a light guide fixing assembly, the light guides are fixed by the light guide fixing assembly, with the light guide fixing assembly including a fixing base and a fastener, constructed to fix the mounting portions of the first ends of the two light guides to the fixing base by pressing them against the fixing base, so that the fastener separates the two mounting portions of the first ends of the two light guides in a first direction.
